(19) United States
(12) Patent Application Publication
(10) Pub. No.: US 2016/0119540 A1
(43) Pub. Date: Apr. 28, 2016

(54) MODEL-BASED PLANE-LIKE PANORAMA AND RETAIL APPLICATIONS

(71) Applicant: Xerox Corporation, Norwalk, CT (US)

(72) Inventor: Wencheng Wu, Webster, NY (US)

(73) Assignee: Xerox Corporation

(21) Appl. No.: 14/521,996

(22) Filed: Oct. 23, 2014

(51) Int. Cl. H04N 5/232; H04N 5/225; H04N 5/265; G06Q 10/08

(52) U.S. Cl. CPC H04N 5/23238; G06Q 10/087; H04N 5/2253; H04N 5/265

(57) ABSTRACT

Methods and systems for developing shelf product location and identification layout for a retail environment. Such an approach can include a mobile base navigable throughout the retail environment, at least one camera mounted on the mobile base acquiring images of aisles, shelving, and product located on the shelving throughout the retail environment; and a computer controlling mobile base movement, tracking mobile base location and orientation, and organizing images acquired by the camera including facing information for product associated with shelving and aisles as images are acquired and input to the computer to generate plane-like panoramas representing inventory, inventory location, and layout of the retail environment.

### FIELD OF THE INVENTION

Embodiments are generally related to imaging methods and systems. Embodiments further relate to image-based and video-based analytics for retail applications.

### BACKGROUND

There are a large number of retail chains worldwide across various segments, including pharmacy, grocery, home improvement, and others. A process that many such chains have in common is sale advertising and merchandising. An element within this process is the printing and posting of sale item signage within each store, very often at a weekly cadence. Some companies and organizations have a business interest in supplying this weekly signage to all stores within a chain.

It would be advantageous to each store if this signage is printed and packed in the order in which a person encounters sale products while walking down each aisle. Doing so eliminates a non-value-add step of manually having to pre-sort the signage into the specific order appropriate tore given store. Unfortunately, with few exceptions, retail chains cannot control or predict the product locations across each of their stores. This may be due to a number of factors: store manager discretion, local product merchandising campaigns, different store layouts, etc. Thus, it would be advantageous to a chain to be able to collect product location data (referred as store profile) automatically across its stores, since each store could then receive signage in an appropriate order to avoid a pre-sorting step.

Researchers have been working on various image-based and video-based analytics for retail applications. An imaging system plays a key role since if provides raw inputs where useful analytics are collected and extracted. Depending on how the imaging system is run, some form of organization or pre-processing may be beneficial.

As an example, for shelf-product layout identification and planogram compliance, it makes sense to pre-process and organize the images based on the orders of aisle, shelf, etc. Since a retail store is large and has a complex 3D layout, it is not possible to have a single snapshot/picture of the entire store. The representation as a whole thus needs to originate from collecting and organizing a large set of images, each of which captures a portion of the store. In a retail setting, a useful image representation is the plane-like panorama of aisles of the store, where each panorama is a snapshot of an aisle or segment. Depending on how the images are collected (e.g., systematically vs. randomly), constructing the panorama can be a daunting task or can be much simpler.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for systems and method for constructing a plane-like panorama of a store-shelf for various retail applications such as, for example, planogram (shelf-product layout) compliance misplaced item detection, inventory management, virtual store applications for shoppers, and so forth

It is another aspect of the disclosed embodiments to provide for an output comprising a collection of plane-like panoramas representing a snapshot of the aisles in a store, which can be further analyzed or rendered for main retail applications.

The aforementioned aspects and other objectives and advantages can now be achieved as described herein. A navigable imaging method and system for developing shelf product location and identification layout for a retail environment can be implemented. Such an approach can include, for example, a mobile base navigable throughout the retail environment, at least one camera mounted on the mobile base acquiring images of aisles, shelving and product located on the shelving throughout the retail environment; and a computer controlling mobile base movement, tracking mobile base location and orientation, and organizing images acquired by the camera including facing information for product associated with shelving and aisles as images are acquired and input to the computer to generate plane-like panoramas representing inventory, inventory location, and layout of the retail environment.

In another embodiment, a method of capturing and organizing images for developing shelf product location and identification layout of a retail environment can be implemented, which includes, for example, the steps of logical operations to provide an imaging system that will navigate and acquire images and determine location of aisles, shelving, and inventory on the shelving throughout a retail environment; track location and facing information of inventory located on the shelving; and input images into a computer to generate plane-like panoramas representing inventory, inventory location, and layout of inventory within the retail environment.

In still another embodiment, a navigable imaging system for developing shelf product location and identification layout for a retail environment can be implemented. Such a system can include, for example, a mobile base including one or more cameras mounted thereon; one or more microprocessors coordinating module activity; a navigation module controlling the movement of the mobile base; an image acquisition module controlling image acquisition by the camera(s) as the mobile base navigates through the retail environment; a characterization module determining spatial characteristics of the navigable imaging system as it moves throughout a retail environment and the camera(s) acquires images of aisles and associated shelving; a vertical spatial look-up-table generation module generating at least one spatial LUT (Look-Up-Table) for use in developing 2D plane-like panoramas of aisles in a vertical direction; a system pose receiving module receiving corresponding system pose information, including imaging system location, distance, and orientation to a shelf plane as images are acquired; and a model-based panorama generation module generating 2-D plane-like panoramas for each aisle utilizing the acquired images, the system pose information, the at least one special LUT, and storing the generated panorama representing aisles, shelving, and product located throughout the retail environment.

The disclosed embodiments are thus directed toward techniques for building panoramas much more efficient by utilizing systematic imaging of the store and modeling techniques. As an example, an imaging system embodiment will navigate and acquire images around the store, while keeping track of location and facing information. These images can be input to the proposed method and system to generate plane-like panoramas representing the store.

Note that there exist standard panorama methods that can perform the same task but require mere strict imaging (e.g., need to have significant overlaps between images) and are less efficient in computation. The differences and benefits of the disclosed embodiments against such standard methods are discussed herein.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrate an example imaging system, which can be used to navigate and image a store systematically, in accordance with a preferred embodiment;

FIG. 2 illustrates a schematic diagram depicting a system for constructing model-based plane-like panorama of store-shelf for various retail applications such as planogram (shelf-product layout) compliance, misplaced item detection, inventory management, virtual store for shoppers, etc. in accordance with a preferred embodiment;

FIG. 3 shows an example robot with an imaging system that has been developed for a shelf production identification project, and which can be implemented in the context of an embodiment;

FIG. 4 illustrates a schematic diagram illustrating the instructed path of a store-shelf scanning robot in a retail store, in accordance with a preferred embodiment;

FIG. 5 illustrates images and a corresponding vertical panorama using the methodology and/or robotic imaging system disclosed herein, in accordance with alternative embodiments;

FIG. 6 illustrates a simple model-based method, in accordance with an alternative and experimental embodiment;

FIG. 7 illustrates a model-based method with cross-correlation stitching at graphic and a ground-truth by taking a single picture at approximately 12 feet away, in accordance with an alternative and experimental embodiment;

FIG. 8 illustrates a navigable imaging system for developing shelf product location and identification layout for a retail environment, in accordance with an alternative embodiment;

FIG. 9 illustrates a diagram depicting single camera FOVs at different distances;

FIG. 10 illustrates a diagram of single camera FOVs at different facing angles to the store shelf plane (top-view not side-view); and

FIG. 11 illustrates the process of building a full panorama from two vertical panoramas, in accordance with an alternative embodiment.

### DETAILED DESCRIPTION

The particular values and configurations discussed in these non-limiting examples can be varied and are cited merely to illustrate at least one embodiment and are not intended to limit the scope thereof.

The disclosed embodiments relate to systems and methods for constructing model-based plane-like panorama of store-shelf for various retail applications such as planogram (e.g., shelf-product layout) compliance, misplaced item detection, inventory management, and virtual store for shoppers, etc. The output is a collection of plane-like panoramas representing a snapshot of the aisles of a store, which can be further analyzed or rendered for many retail applications.

The disclosed embodiments can include the following modules, which will be discussed in greater detail herein: (1) an imaging system characterization module which determines spatial characteristics of the imaging system, [off-line]; (2) a vertical spatial look-up-table generation module which generates spatial look-up-table(s) (LUTs) to be used for on-line building of plane-like panorama in vertical direction, [off-line]; (3) a navigation and image acquisition module which acquires images using the characterized imaging system as it navigates through the retail store; (4) a system pose receiving module which receives the corresponding system pose information, such as location of imaging system, distance, and orientations to the shelf plane as each image is acquired; and (5) a model-based panorama generation module which generates 2-D plane-like panorama utilizing the acquired images, the received system poses, and the generated vertical panorama model(s) (e.g., the spatial LUTs in (3)).

The disclosed embodiments can be implemented to accelerate the process of determining the spatial layout of products in a store (i.e., the example use case) as well as other retail applications. One of the goals of the invention is to provide a system and method (e.g., a service), which images the store and determines the spatial layout of products in a store. An insertion of such services to customer sites would enable the collection of a huge amount of (e.g., proprietary) data/images and analytics that in turn would enable new services. Example new services include planogram (shelf-product layout) compliance, misplaced item detection, inventory management, and virtual store for shopper, etc. The disclosed embodiments are a critical component to implementation of a store imaging system, which will organize the collection of huge image dataset into a normalized and relevant image representation that would enable those new services. This image representation can be referred to as a plane-like panorama of the store shelf. Each plane-like image panorama represents a snapshot of an aisle/segment of a store shelf, which can be analyzed for determining planogram compliance, inventory management, misplaced stem detection, etc., if compared to expected reference images. The collection of the plane-like image panoramas can also be rendered into a 3D virtual world for a virtual store given store floor-plan.

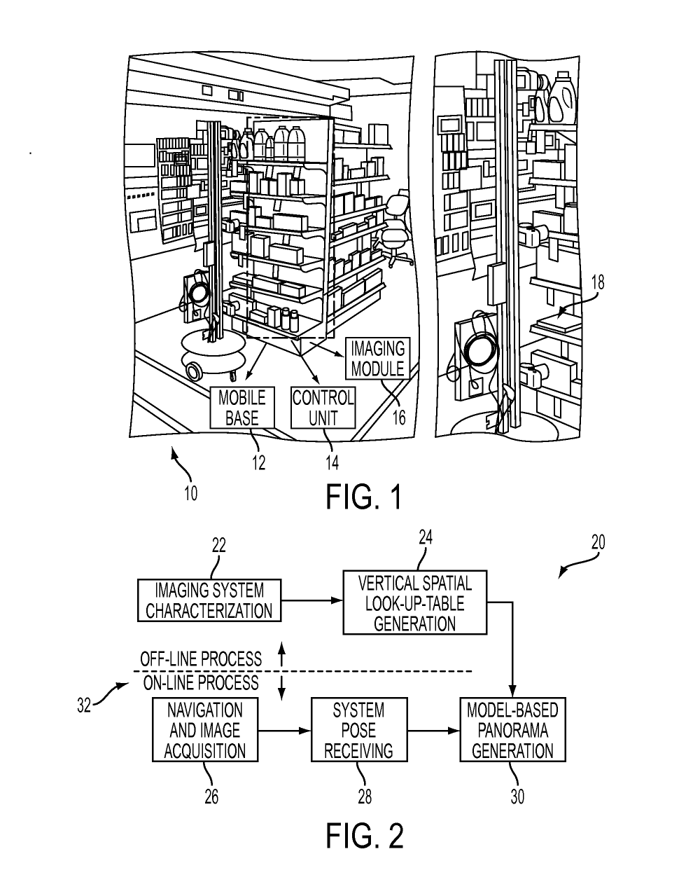

FIG. 1 illustrates an example imaging that system 10, which can be used to navigate and image a store systematically, in accordance with a preferred embodiment. As shown in FIG. 1, a mobile base 12 can navigate around the store while an imaging module 18 acquires images as instructed by a control unit 14 (e.g., a small form-factor computer). The system 10 can navigate and acquire images around the store, while keeping track of location and facing information associated with how these images are acquired. These images can be input to the disclosed methodology to generated plane-like panoramas representing the store. FIG. 1 thus depicts an example image system 10, which can be implemented in the context of a retail store. The graphic at the right of FIG. 1 is a detailed view of the imaging system 18 arrangement which can include the use of a 3-camera array with 2-position capability (e.g., a motorized rail).

FIG. 2 illustrates a schematic diagram depicting a system 20 for constructing model-based plane-like panorama of store-shelf for various retail applications such as planogram (shelf-product layout) compliance, misplaced item detection, inventory management virtual store for shoppers, etc., in accordance with a preferred embodiment. The output is a collection of plane-like panoramas representing a snapshot of the aisles of a store, which can be further analyzed or rendered for many retail applications. System 20 includes a number of modules, including, for example, an imaging system characterization module 22, which determines spatial characteristics of the imaging system [e.g., off-line], and a vertical spatial look-up-table generation module 24 which generates spatial look-up-table(s) (LUTs), referred as vertical panorama models, to be used for on-line building of plane-like panorama in vertical direction [e.g., also off-line].

System 20 also includes a navigation and image acquisition module 28, which acquires images using the characterized imaging system as it navigates through the retail store. System 20 also includes a system pose receiving module 28 which receives the corresponding system pose information, such as location of imaging system, distance, and orientations to the shelf plane, as each image is acquired. Finally, system 20 can include a model-based panorama generation module 30, which generates 2-D plane-like panorama utilizing the acquired images, the received system poses, and the generated vertical panorama model(s). Note that the off-line process versus the on-line process is indicated in FIG. 2 by dashed line 32.

The imaging system characterization module 22 determines the spatial characteristics of the imaging system. The outputs of module are spatial profiles describing the relationship of image pixel coordinates and the real-world coordinates.

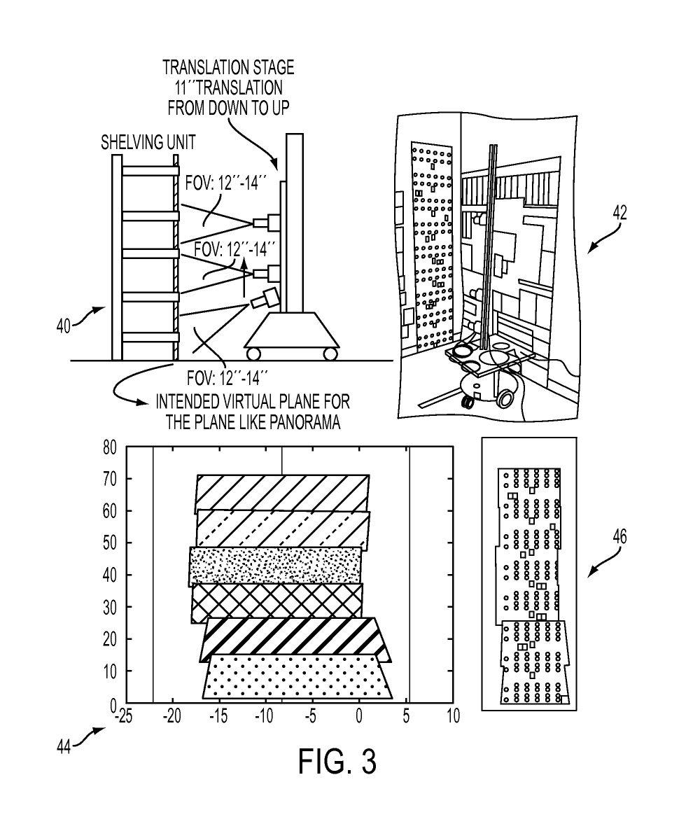

FIG. 3 shows an example robot with an imaging system that has been developed for a shelf production identification project, and which can be implemented in the context of an embodiment. Such an example configuration can be chosen to cover a maximal shelf height of, for example, 6 feet. Graphic 40 in FIG. 3 illustrates intended parameters of the imaging system including the virtual plane intended for building plane-like panorama. Graphic 42 depicted in FIG. 3 indicates a photo of an actual system looking at a calibration target at a wall of a store. Graphic 44 shown in FIG. 3 shows a plot of the characterized FOVs of a 6 sub-imaging system. Finally, graphic 46 depicted in FIG. 3 illustrates the vertical panorama of the calibration target on the wall using the disclosed methodology. It should be appreciated that the proposed method here is not limited to a specific configuration.

As shown in graphic 44, the outputs of this module are six camera projective matrices,

P_{k(d)}:(i,j)→(x,z)k=1˜6

where d is the distance from the imaging system to shelf plane of interest. Since our imaging system is really a system of 3 cameras with 2-positional array rather than a system of 6 cameras, the six camera projective matrices can also be represented by 3 camera projective matrices with two possible sets of translation parameters. Without loss of generality, our discussion in the remaining document will treat these six camera projective matrices as if they are completely independent.

The vertical spatial look-up table generation module 24 [off-line] generates spatial look-up-table(s) (LUTs), referred as vertical panorama models, to be used for on-line building of plane-like panorama in vertical direction. The key idea is to pre-construct a spatial look-up-table(s) including pixel indices and optionally interpolation weights based on the determined spatial characteristics of the imaging system from the previous module.

As an example, the outputs of the imaging system characterization modules may P_{k(d)}:(i,j)→(x,z) k=1˜6, where d is the distance from the imaging system to shelf plane of interest. Our typical operation for shelf product identification uses d=2.5′ as the nominal value. However, it is beneficial to characterize the imaging system at multiple distances around nominal since the mobile base may not always be able to navigate exactly. This would also allow our algorithm to compensate the imperfection of navigation for better quality panorama if desired.

For simplicity, let us assume that the mobile base can indeed navigate close enough to d=2.5′. We thus only need Pₖ^{(2.5)}, k=1˜6. One embodiment of building the spatial LUT is as follows:
Make the x-center of Pₖ^{(2.5)} to 0 by adding an offset in the system, an offset is added so that the average x of the top camera equals to 0. The center of x should be moved, but not z since the characterization system is absolute in z but relative in x.
Determine the desired resolution of Δx and Δz in the final model-based panorama. For many retail applications, the present inventors have found that 0.025″ are more than sufficient.
Create 2-D mash-grid of x=−NΔx˜NΔx, z=Δz˜MΔz, i.e., creating a set of (x,z) coordinates that correspond to an image of M×(2N+1) array with physical size of height=MΔz and width=(2N+1)Δx that center at x=0.
Create a spatial LUT that has M×(2N+1) entries, each entry stores the image sequence ID(k), the pixel location(s) to be used for reconstructing this entry online, and optionally the weights for interpolation among these pixels. Conceptually, the spatial LUT is like a map that tells you for each pixel (xᵢ,zᵢ) in the panorama where you should find the image data out of the k images and how to use them for interpolating the data.

There can be many embodiments for the final step. The simplest embodiment can involve building a spatial LUT that achieves nearest neighbor interpolation. To do that, a pseudo code such as disclosed below can be employed:

```
  For each (xᵢ,zᵢ), find the LUT entry (k, iₖ, jₖ) by
    1. Initialize (k, iₖ, jₖ) = (0,0,0)
    2. For I=1~6,
      2.1 Perform inverse spatial mapping on (xᵢ,zᵢ), using Pᵢ^{(d)}, i.e., (î,ĵ) =
(Pᵢ^{(d)})⁻¹(xᵢ,zᵢ).
      2.2 If(î,ĵ) is within the image dimension of I^{th} image, then
update (k, iₖ, jₖ) to I,round(î), round(ĵ).
```

If (k, iₖ, jₖ)=(0, 0, 0) for a point after the above algorithm, that means that there is no data available for interpolate that point in panorama (e.g., a hole in the imaging system due to none-overlap region or simply out of the range of the FOVs of the imaging system). If a point is at the overlap region among multiple sub-imaging system, the above algorithm would use the data from the largest k (in our case, if is the bottom camera). One can also consider computing average rather than just picking one. This method does not store any weight since it uses the nearest neighbor interpolation scheme. The “nearest neighbor” comes from the operation: d(·). For a given resolution of panorama, this method stores the smallest LUT and is most efficient in computation. Conceptually, it is equivalent to pick pixel value directly (without any interpolation) from k images to fill in the panorama.

The above pseudo code can be easily extended to higher order interpolation. For example, to extend it into bilinear interpolation that uses 4 neighboring pixels with weights, one only need to replace the operation round(·) with fractional numbers and use the fraction and 1-fraction, as the weights. However, special care needs to be considered when the pixel is at the image border since the 4 neighboring pixels may come from different images now. In any case, this is not a limitation of our algorithm just more complicated.

This spatial LUT can be referred to as the vertical panorama model because its role is to stitch the k images acquired by our imaging system along the vertical direction. As our imaging system move along the aisle of the store, we would then stitch these individual vertical units of panorama along the horizontal direction to form a full panorama of the aisle. More details will be discussed below.

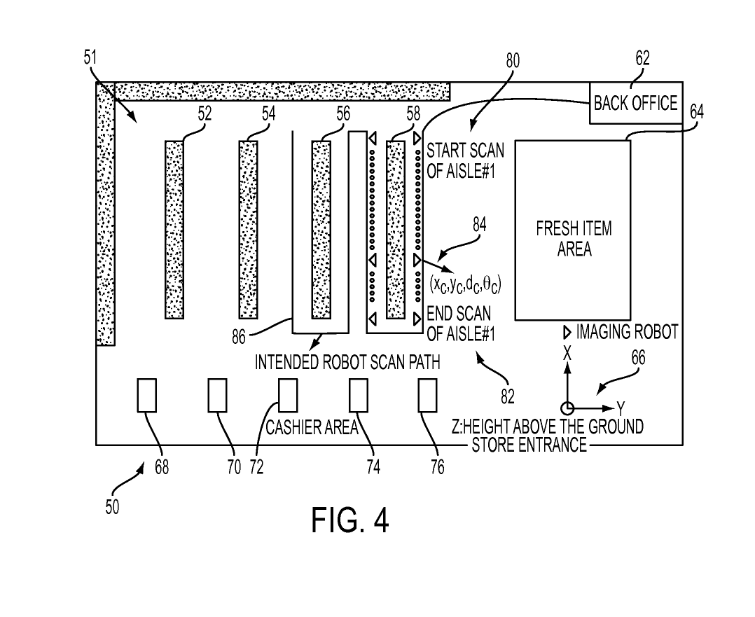

FIG. 4 illustrates a schematic diagram illustrating the instructed path of a store-shelf scanning robot in a retail store 51, in accordance with a preferred embodiment. The example retail store 51 shown in FIG. 4 includes, for example, store shelves 52, 54, 56, and 58, a back office 82, and a fresh items area 64. A cashier area includes a plurality of cashier stations 68, 70, 72, 74, and 78. At position 80, an operation is indicated—start scan of aisle #1. The end scan of aisle #1 is shown at position 82. Coordinates are indicated by arrow 82. X-Y coordinates 66 are also shown in FIG. 4.

Note that the navigation and image acquisition module 26 acquires images using the characterized imaging system as it navigates through the retail store. As the robot navigates through the store, the control unit 14 will instruct the disclosed imaging system to acquire images of the store shelf while keeping track of the positions and poses, where images are acquired. Depending on the imaging system and applications, the image acquisition can be in a continuous mode (i.e., video) or in a stop-and-go fashion. For the system depicted in FIG. 3, since there are moving parts (motorized rail for 2-position translation) it is preferred to have the image acquired in a stop-and-go fashion. However, this is not a limitation of the disclosed embodiments.

The system pose receiving module 28 receives the corresponding system pose information, such as the location of imaging system, distance, and orientations to the shelf plane for panorama as each image is acquired. The information can be very condensed such as: start of aisle #1 with 12″ every step and we are at step #5. The information can also be very detailed such as the current position and facing of the centerline of the imaging system is (x_{c}, y_{c}, d_{c}, θ_{c})=(118″, 311″, 2.5′, 2°) relative to a reference store coordinate and origin. The latter is preferred since we can always back calculate them to find out the aisle and shelf information. The former is simpler and can work well if the navigation system is quite accurate.

The model-based panorama generation module 30 generates 2-D plane-like panorama utilizing the acquired images, the received system poses, and the generated vertical panorama model(s). Conceptually, as acquired images enter the module, it will first create a vertical panorama (i.e., along z-direction) from a set of k images using the spatial LUT (perform fine-tune if the camera pose (d_{c}, θ_{c}) deviates too much from nominal), and tag the vertical panorama with the current imaging location (x_{c}, y_{c}). Note that each resulting vertical panorama will have the size of height=MΔz and width=(2N+1)Δx that center relatively at x=0. The size should cover the full height of the store-shelf with a width roughly equal to or larger than the field of view of the cameras. Based on the location information (x_{c}, y_{c}), these vertical panoramas can then be stitched together along the horizontal direction (x-direction).

To help understand this module, we will describe the whole process in a stop-and-go scenario with example numbers. Assuming that the camera FOV in x is 20″ and the robot is instructed to move 18″ per step in x while maintaining a distance of 2.5′ from the shelf with a pose of 0° (direct facing). Using FIG. 4 as an example floor plan and FIG. 3 as an example imaging system, the robot would first navigate from the back office to the start scan of aisle #1.

Once the robot is in position, the imaging system will acquire 6 images. A vertical panorama (VP) will be created using these 6 images and the spatial LUT discussed earlier. The width of the panorama may be trimmed to keep the center 18″. The robot would then move to the next position (18″ away along the aisle); acquire another set of 6 images; and build another vertical panorama trimmed to 18″ in width. After this step, we can stitch the 2 18″-wide vertical panoramas side by side to create a 36″-wide panorama. Repeat this process until the robot reaches the end of scan of aisle #1. We now have the full 2-D panorama for aisle #1. Repeat this process until all aisles have been scanned. Note that for a robot with capable navigation, this would be the easiest and most effective method. For less accurate navigation, algorithms discussed here can be used.

Note that depending on the navigation capability of the robotic imaging system and how well the sub-imaging system aligned, more conservative or aggressive margins between FOV and step size can be used, in our experiment section, we use a more conservative margin (only move 12″ per step) since our navigation system has not yet optimized in our prototype.

Other methods and tools exist for building panorama from a collection of photos; however, the prior art is aiming to solve a bigger and more challenging problem: 3D scene, any camera type or pose, uncontrolled environment, etc. Good performance is not guaranteed and computation is expensive, A most common set of approaches use feature-based image registration techniques, which find and match features among photos, use them to register against each other, and apply some regularity techniques to smooth the results. As a result, it is necessary to have: (1) significant portion of overlaps among the collection of photos; (2) sufficient features/textures extracted from each photo; and (3) heavy computation, etc.

In retail applications contemplated for the present invention, retail store operators are provided the control to “plan” how the images are collected, have the information about the camera poses, and mostly interest in the plane that align with the store shelf (in retail, the term planogram is used to describe the image of that plane). it would be a waste not to use this to the operators advantage. The embodiments discussed herein utilize this feature fully. Furthermore, in retail applications, imposing significant portion of overlaps (e.g., use video mode, which has lower spatial resolution though) when acquiring store shelf images is not desired since it would increase the time needed to image the entire store. Many items on the shelf looks alike (e.g., a shelf with bottles of soda would have many bottles that look the same). This presents itself as a repeated pattern that cannot be resolved uniquely by simple feature matching. Additionally, heavy computation means an expensive computational resource, which is not desired due to costs.

It is thus neither preferred nor feasible in many retail applications to use standard panorama methods. By limiting the focus to a more relevant and simpler problem, controlled imaging and plane-like panorama, the proposed model-based panorama approach described herein suits retail applications very well.

Additionally, the disclosed method has several unique and new features. Although the “de-warping and stitching” involved in building a vertical panorama from a set of k images can be done in real-time by solving the inverse problem, our spatial LUT (that built off-line) approach offers a very efficient on-line solution. New features are discussed herein that compensate or resolve issues due to deviation between actual robot scanning path and the planned scanning path. The idea of stitching vertical panoramas info full panorama using navigation information is one of the key ideas disclosed herein.

Experimental Results

The methods and systems proposed in the present disclosure have been implemented with a combination of MATLAB and OpenCV C++. This system has been fully developed and tested, and can be readily implemented in retail applications, as of the priority date of the present patent disclosure. A demo robot system, which is illustrated in some of the drawings herein, can be deployed along with mobile retail application solutions (e.g., robots for retail applications to enable other future offerings such as planogram (shelf-product layout) compliance, misplaced item detection, inventory management, and virtual store applications, etc.).

In this section, an experiment of a mock-up store using a specific embodiment of a current system in use as shown in graphic 42 of FIG. 3 is shown. In particular, the present inventor uses an imaging system composed of, for example, a 3-camera array with 2-positional capability. Its spatial characteristics are shown in graphic 44 in FIG. 3. The description here is to show feasibility and should not be mistaken as limitations. The prototype robot with our imaging system is fully functional except the autonomous navigation at the time of this experiment. The present inventor used manual remote joystick navigation in our lab for demonstration of feasibility.

Experimental Environment

Two mock-up stores were created: a wall-poster store and an actual U-shape store. Both results are available. Wall-poster store results are discussed herein by way of example, since such an example scenario involves a store With one aisle only and is easier to explain as an illustrated example. The wall-poster store can be created by printing life-size planograms from an actual retail store and then posting them on the wall. Additionally, many barcodes can be posted everywhere to test barcode reading capability and other irrelevant photos on the wall. The robot is fully functional except autonomous navigation as mentioned earlier. This means that we do not have accurate feedback on the location and pose information in this experiment.

Hence, the system pose receiving module 28 may only receive coarse location information, i.e., the intended step size (12″ in this experiment), what is the step number counted from the start of the aisle, the intended distance to the shelf (2.5″), and the intended facing (0°). As a result, distance or orientation compensation techniques were not applied. Results, however, are shown using a simple model-based method versus using a more capable model-based method.

The imaging system was characterized as shown in graphic 44 of FIG. 3. The outputs are used by our spatial LUT generation module to generate a LUT covering 80″×27.725″ at a resolution of 0.025″ for both x- and z-directions. The height range can be selected in some cases to be a bit over 6 feet to cover the maximal height of the store-shelf of interest. The width range can be determined based on the widest FOV from the imaging sub-system plus a few inches of margins. The reason that these extra margins were set was to allow the system to be able to build panorama with holes (i.e., missing data) and is sufficiently large even if the navigation system takes a larger step than intended.

As shown in graphic 46 of FIG. 3, there are large portions of missing data using this spatial LUT. However, an operator can always trim the vertical panorama to keep only the portion with sufficient data. Note that the hole in the data is not necessarily negative in some cases, since they may be recovered via interpolation techniques. What is gained from the holes is a faster scan time of the store if the skipping portion is not important to the task or can be recovered from other image processing techniques.

Experiment and Results

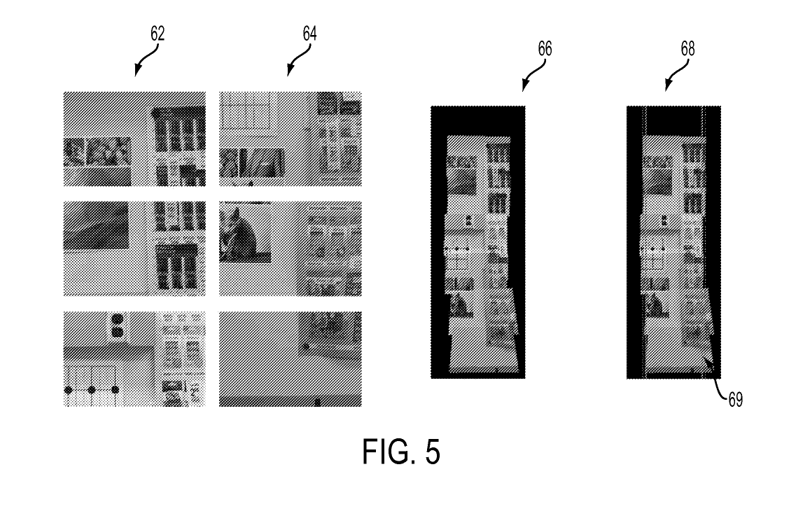

FIG. 5 illustrates images and a corresponding vertical panorama using the methodology and/or robotic imaging system disclosed herein, in accordance with alternative embodiments. Images 62 and 64 depict raw images (6 images) from each sub-imaging system in the order of camera #1 at “up” position, camera #1 at “down” position, camera #2 at “up” position, camera #2 at “down” position, camera #3 at “up” position, and camera #3 at “down” position (from top to bottom, left to right). Graphic 66 shown in FIG. 5 is a raw vertical panorama from our algorithm without trim, and graphic 68 is the same as that shown in graphic 66 but with trim lines shown.

During the experiment, the robotic imaging system can be initially navigated to the start of the aisle of the wall-poster store and image. Graphics 62 and 64 of FIG. 5 show the set of 6 images acquired prior to a corresponding vertical panorama is built. Pixel values in these 6 images are picked out to create the vertical panorama (VP) shown in graphic 66 based on the spatial LUT built using our module/algorithm and nearest neighbor interpolation.

As mentioned earlier, the spatial LUT was built larger than FOVs of the imaging system. For building the full panorama of the wall-poster store, we only use the portion up to within the 2 red lines. The 2 red-lines are 1″ inward from the 2 red dashed-lines. The two red dashed-lines are determined based on the locations where no more than 50% missing data is allowed. They are determined off-line purely based on the spatial LUT built. We then move the robot to the right by about 12″ using manual joy-stick control and acquire the next set of 6 images. Although the distances to the wall/shelf and the facing angle should be maintained, there are errors and there were no present means to measure them easily in the experimental prototype.

These errors were thus considered as uncontrollable and non-measureable noises in the experiment This process was repeated until the robot reached the end of the aisle (12 times for our “wall-poster store”). That is, there were 12 VPs (an example VP is shown in graphic 68 within 2 red lines) to work with for creating the full panorama of the aisle.

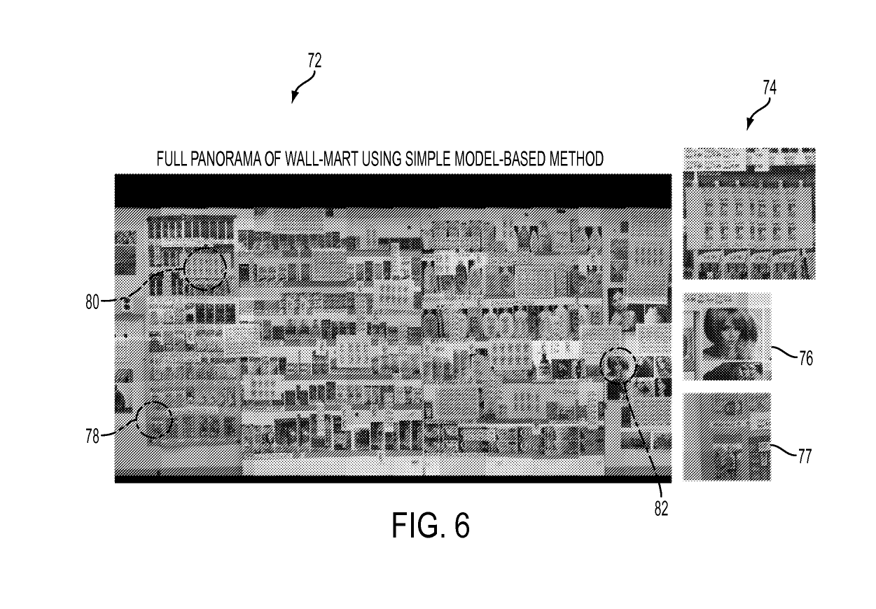

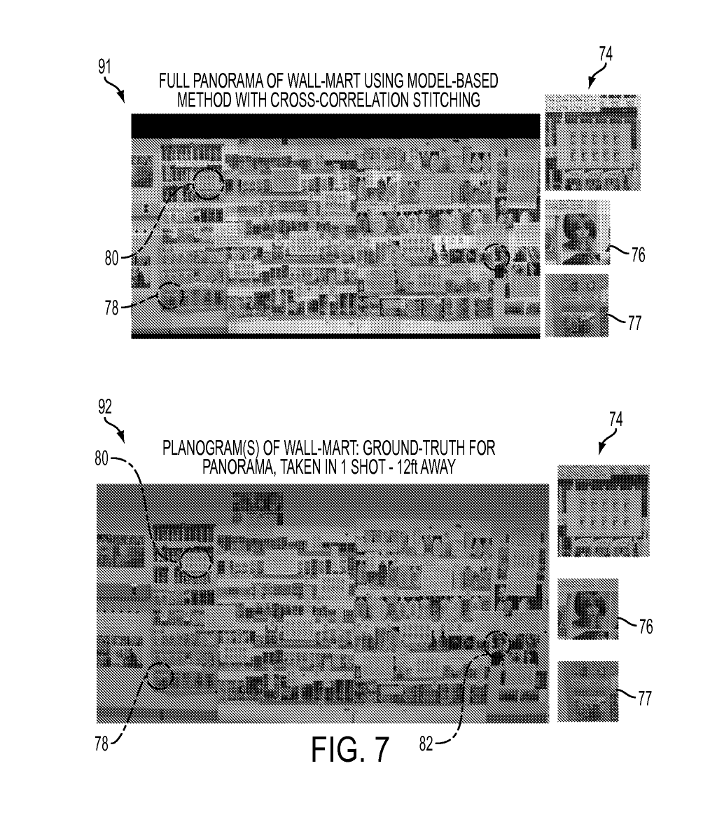

FIGS. 6-7 illustrate the results of the disclosed model-based panorama methodology, in accordance with an alternative embodiment. FIG. 6 illustrates a simple model-based method at graphic 72. FIG. 7 illustrates a model-based method with cross-correlation stitching at graphic 91 and a ground-truth by taking a single picture at approximately 12 feet away as shown at graphic 92.

FIG. 6 shows the result using a simple model-based method, which crops out the center 12″ portion of each VP and stitches them in order. We also show zoom-in version of three regions 80, 78, and 82 (circled on the panorama), which correspond to images 74, 76, and 77, respectively shown at the left hand side of FIG. 6. In a global sense, the final panorama is sufficient for some applications (e.g., virtual store) but may not be good enough for others (e.g., misplaced item detection). The stitching errors are mainly due to navigation errors. This would not be an issue with our 3^{rd} party demo robot, which claims to have centimeter navigation accuracy indoor.

FIG. 7 shows the result using a model-based method with cross-correlation stitching. The details of the method are discussed in greater detail herein. This method can deal with inaccurate navigation. As shown in the figures, the results are much better. Graphic 92 shows one form of ground-truth that was derived by taking a single shot of the wall-poster store aisle (i.e., no stitching).

A few remarks about the results are discussed in the following. In practice, it is not possible to obtain a single picture of the entire aisle because the aisle may be longer and there is no space to take a picture of it at 12 ft (or more for longer aisle) away. Hence some stitching, panorama approach, may be needed. Our panorama (e.g., see graphic 91 in FIG. 7) is actually better than the single shot ground-truth (i.e., see graphic 92 of FIG. 7). The images can be de-warped as part of the disclosed spatial LUT process. The single shot image may have some distortion unless de-warping is applied. That is, the spatial LUT can be employed for single shot as well (i.e., k=1), which is not a surprise. Furthermore, the VP can be built from, for example, 6 high resolution camera shots, each covering a smaller FOV (Field of View). Hence, the full panorama built from our 12 VPs can have a much higher spatial resolution than the one acquired via a single camera shot. If high resolution is necessary for a particular retail application, all we need to do is to build a finer spatial LUT.

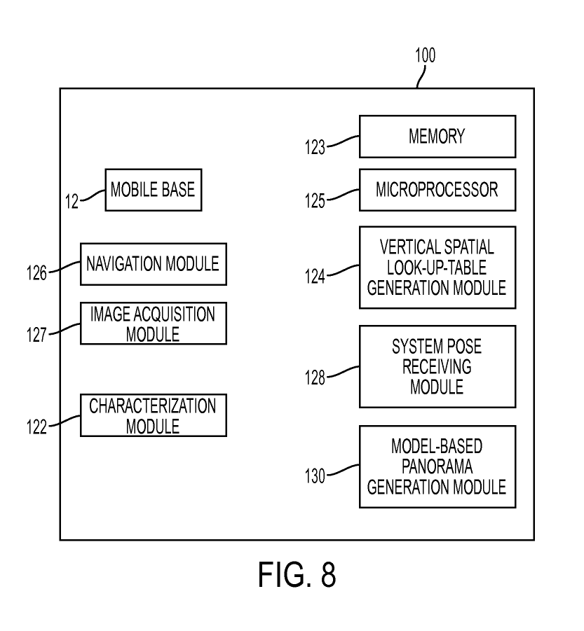

FIG. 8 illustrates a navigable imaging system 100 for developing shelf product location and identification layout for a retail environment, in accordance with an alternative embodiment. Note that in FIGS. 1-8 herein, similar parts or elements are indicated by identical reference numerals. For example, the system 100 configuration shown in FIG. 8 is similar to the system 20 depicted in FIG. 2 with some variations. System 100 includes mobile base 12 including at least one camera mounted thereon. System 100 further includes at least one microprocessor 125 for coordinating module activity.

System 100 also includes a navigation module 120 that controls the movement of the mobile base 12, an image acquisition module 127 that controls image acquisition by the at least one camera as the mobile base 12 navigates through the retail environment, along with a characterization module 122 that determines spatial characteristics of the navigable imaging system as it moves throughout a retail environment, and at least one camera that acquires images of aisles and associated shelving.

System 100 further includes a vertical spatial look-up-table generation module 124 capable of generating at least one spatial look-up-table (LUT) for use in developing 2D plane-like panoramas of aisles in a vertical direction, and system pose receiving module 128 capable of receiving corresponding system pose information, including imaging system location, distance, and orientation to a shelf plane as images are acquired. System 100 also includes a model-based panorama generation module 130 that can generate 2-D plane-like panoramas for each aisle utilizing the acquired images, the system pose information, and storing the panoramas in the at least one spatial LUT as vertical panorama images representing aisles, shelving, and product located throughout the retail environment. System 100 can also include a memory 123 within which such modules (assuming software modules) can be stored.

Distance Compensation for Spatial LUT

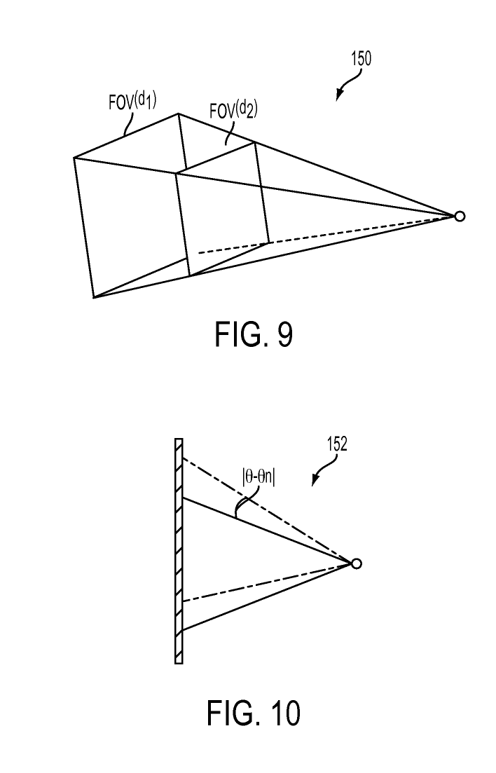

FIG. 9 illustrates a diagram 150 depicting single camera FOVs at different distances. The FOVs of a camera at various distances will converge to a single point (thus the characteristics of focal point, focal length . . . ). That is, the spatial profile of the FOV of a camera at distance d₁ and that at d₂ are related. In fact, if one were to use a coordinate system that is normalized by the distance to the center of the camera, then the spatial profiles of all FOVs can be reduced into one. FIG. 9 illustrates this relationship, in a simple term, the sizes of the FOVs are inversely proportional to the distance to the camera center. Furthermore, since the images acquired by a camera are integrated values sampling on a grid of each FOV, it is possible to modify our special LUT prepared for one distance (say d₁) to spatial LUT that is appropriate for another distance (say d₂) if the slope of the “inversely proportional” gain is known or characterized.

A simple and practical way to characterize the gain is to use the camera to acquire a common scene (ideally test target) at two different distances. The discussion above can be extended to an imaging system that consists of multiple cameras by applying different gain modifications for each camera (sub-imaging system). Since the spatial LUT can be prepared for nominal distance always keep track of the source of cameras (k), the compensation for variation of distances due to imperfect navigation can be done as discussed. It is thus possible to compensate the distance errors directly from post modifying the spatial LUT entries given the actual distance of the acquisition.

Orientation Compensation for Spatial LUT

FIG. 10 illustrates a diagram 152 of single camera FOVs at different facing angles to the store shelf plane (top-view not side-view). The fundamental of compensating camera angle θ to its nominal angle θₙ is very similar to distance compensation, but slightly more complicated. The idea is illustrated in FIG. 10. Without going into details, for our application, we can assume that the amount of the deviation, |θ−θₙ|, is small. We can thus use small angle approximation such as
sin α≈α, cos α≈1−α, tan α≈α if |α| is small and in radian unit.

Furthermore, the angle variation of the imaging system comes from the facing error, i.e., the robot may not directly face the shelf due to navigation pose error. This is a much simpler angle error that varies only along one axis rather than three in a general case. For this more restricted variation, the spatial LUTs a one angle is only a shear-version (shear, shifted, and scaled only in x-direction) of that at another angle (see FIG. 10); and the shift and scale amounts are function of cosine or tangent, which can be approximated linearly by |θ−θₙ| in radian. If is thus possible to compensate the orientation/facing errors directly from post modifying the spatial LUT entries given the actual orientation of the acquisition.

Methods for Stitching Vertical Panoramas along Horizontal Direction

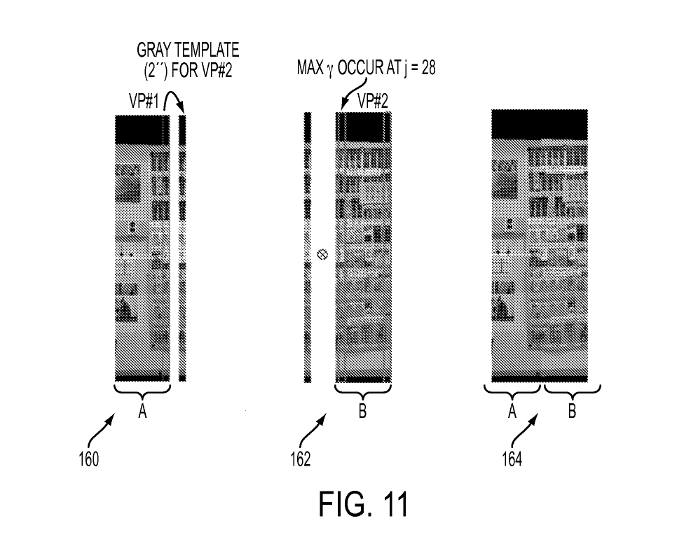

FIG. 11 illustrates the process of building a full panorama from two vertical panoramas, in accordance with an alternative embodiment. Graphic or image 160 depicts VP #1 with left-most 2″ cut out as template, A starts at 0 and ends at 2″ before the graphic or image 182, which depicts a run cross-correlation between template and VP #2 to find max γ location. B start at 28 and ends at 2″ before (note that the left-most 2″ of VP #2 is cut out as template for VP #3 not shown) graphic or image 164, which is a full panorama configured by stitching A and B together. Note that full wall panorama following this method is shown and discussed herein in the experimental sections.

Earlier herein, it was described that the simplest way to stitch vertical panoramas along horizontal direction by simply trim the center portion of each vertical panorama to a size that equal to the step size of the robot/imaging movement and then put them side by side. This works well if the navigation of the robot is sufficiently accurate and the step size is known. On the other extreme, an operator can also use the standard panorama techniques that detect features on each vertical panorama and then image-register them to form the complete panorama. This does not work well in practice for sparse sampling that has little overlaps. Even worse, in retail setting, the image content typically has repeated patterns (the shelf-facing would have more than one bottle of soda and all bottles of one type of soda look the same). This makes the feature-based image registration method error-prone as is.

One remedy is to constrain the problem to (1) only allow horizontal image registration and (2) only search the solutions locally assuming that each step size is roughly known. That is, if we only use standard registration-based panorama method to fine-tune the portion to keep/trim in the simplest method and then still stitch them simply side by side, the method can then work well, but standard registration-based panorama methods are computational expensive and prefer high resolution source images (so that distinct and reliable features can be detected).

Alternatively, an operator can use simple cross-correlation methods to stitch these vertical panoramas along horizontal direction. Using two vertical panoramas (VPs) as an example, let us assume that we are acquiring images from left to right (i.e., the first vertical panorama is on the left and the second is on the right and we want to stitch them from left to right). An operator can thus use a portion of the right-most segment of the first vertical panorama as the template and compute the cross-correlation values as it slides horizontally against the entire (or just some left-portion) of the second vertical panorama. The location where maximal cross-correlation value occurs will be the location where the two images overlapped, thus the two vertical panoramas should be trim and stitch there accordingly.

A visual illustration of this process is shown in FIG. 11. The portion, which is used as a template, needs to be selected based on the knowledge of how much overlap in our navigation and imaging system. Clearly, if there is no overlap, then an operator really cannot create a full panorama without holes. If there is too much overlap, then an operator would be wasting a large amount of imaging acquisition that is not needed. There are also other factors that may determine the amount of overlap such as what is a good overlap for barcode recognition, etc. This is beyond the scope of this discussion.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A navigable imaging system for developing shelf product location and identification layout for a retail environment, comprising:
a mobile base navigable throughout the retail environment;
at least one camera mounted on said mobile base acquiring images of aisles, shelving, and product located on the shelving throughout the retail environment; and
a computer controlling mobile base movement, tracking mobile base location, and orientation, and organizing images acquired by said at least one camera including facing information for product associated with shelving and aisles as images are acquired and input to the computer to generate plane-like panoramas representing inventory, inventory location, and layout of the retail environment.

2. The navigable imaging system for developing shelf product location and identification layout for a retail establishment of claim 1, wherein acquired images represent a plane-like panorama of each aisle and associated shelving in the retail environment.

3. The navigable imaging system for developing shelf product location and identification layout for a retail establishment of claim 2, wherein each panorama is a snapshot of each aisle and associated shelving in the retail environment.

4. The navigable imaging system for developing shelf product location and identification layout for a retail establishment of claim 2, wherein said images of each aisle are processed and organized based on aisle location within the store, shelving location within aisles and product carried on shelving, and said images ordered for shelf-product layout identification and planogram compliance.

5. The navigable imaging system for developing shelf product location and identification layout for a retail establishment of claim 2, wherein said images are used for constructing a model-based plane-like panorama of store-shelf for various retail applications including at least one of: as planogram for shelf-product layout within the store, compliance, misplaced item defection, inventory management, and support of virtual shopping with the retail environment.

6. The navigable imaging system: for developing shelf product location and identification layout for a retail establishment of claim 5, wherein the model is derived based on knowledge of imaging configuration and the tracked mobile base location.

7. The navigable imaging system for developing shelf product location and identification layout for a retail establishment of claim 5, wherein the model is further refined based on the tracked mobile base orientation.

8. The navigable imaging system for developing shelf product location and identification layout for a retail establishment of claim 5, wherein the model is represented in the form of at least one look-up table for efficient real-time computation.

9. The navigable imaging system for developing shelf product location and identification layout for a retail establishment of claim 5, wherein interpolation is conducted among look-up tables based on tracked mobile base orientation and calculated distance to the shelf.

10. The navigable imaging system: for developing shelf product location and identification layout for a retail establishment of claim 5, wherein the generation of model-like plane-like panorama further comprises refining the stitching of acquired images based on the image content similarity near the border of the images from consecutive imaging locations.

11. A method of capturing and organizing images for developing shelf product location and identification layout of a retail environment, comprising:
provide an imaging system that will navigate and acquire images and determine location of aisles, shelving, and inventory on the shelving throughout a retail environment;
track location and facing information of inventory located on the shelving; and
input images into a computer to generate plane-like panoramas representing inventory, inventory location, and layout of inventory within the retail environment.

12. The method of capturing and organizing images for developing shelf product location and identification layout of a retail environment of claim 11, wherein acquired images represent a plane-like panorama of each aisle and associated shelving in the retail environment.

13. The method of capturing and organizing images for developing shelf product location and identification layout of a retail environment of claim 11, wherein each panorama is a snapshot of each aisle and associated shelving in the retail environment.

14. The method of capturing and organizing images for developing shelf product location and identification layout of a retail environment of claim 11, wherein said images of each aisle are processed and organized based on aisle location within the retail environment, shelving location within aisles and product carried on shelving, and said images ordered for shelf-product layout identification and planogram compliance.

15. The method of capturing and organizing images for developing shelf product location and identification layout of a retail environment of claim 11, wherein said images are used for constructing model-based plane-like panorama of store-shelf for various retail applications including at least one of: as planogram for shelf-product layout within the store, compliance, misplaced item detection, inventory management, and support of virtual shopping with the retail environment.

16. A navigable imaging system for developing shelf product location and identification layout for a retail environment, comprising:
a mobile base including at least one camera mounted thereon;
at least one microprocessor coordinating module activity;
a navigation module controlling the movement of the mobile base;
an image acquisition module controlling image acquisition by said at least one camera as the mobile base navigates through the retail environment;
a characterization module determining spatial characteristics of the navigable imaging system as it moves throughout a retail environment and said at least one camera acquires images of aisles and associated shelving;
a vertical spatial look-up-table generation module generating at least one spatial look-up-table (LUT) for use in developing 2D plane-like panoramas of aisles in a vertical direction;
a system pose receiving module receiving corresponding system pose information, including imaging system location, distance, and orientation to a shelf plane as images are acquired; and
a model-based panorama generation module generating 2-D plane-like panoramas for each aisle utilizing the acquired images, the system pose information, the at least one spatial LUT, and storing the generated panoramas representing aisles, shelving, and product located throughout the retail environment.

17. A navigable imaging system for developing shelf product location and identification layout for a retail establishment of claim 16, wherein acquired images represent a plane-like panorama of each aisle and associated shelving in the retail environment.

18. A navigable imaging system for developing shelf product location and identification layout for a retail establishment of claim 16, wherein each panorama is a snapshot of each aisle and associated shelving in the retail environment.

19. A navigable imaging system for developing shelf product location and identification layout for a retail establishment of claim 16, wherein said images of each aisle are processed and organized based on aisle location within the retail environment, shelving location within aisles and product carried on shelving, and said images, ordered for shelf-product layout identification and planogram compliance.

20. A navigable imaging system for developing shelf product location and identification layout for a retail establishment of claim 16, wherein said images are used for constructing model-based plane-like panorama of store-shelf for various retail applications including at least one of: as planogram for shelf-product layout within the retail environment, compliance, misplaced item defection, inventory management, and support, of virtual shopping with the retail environment.
